(19) United States
(12) Patent Application Publication
(10) Pub. No.: US 2010/0268972 A1
(43) Pub. Date: Oct. 21, 2010

(54) METHOD AND APPARATUS FOR CONTROLLING CLOCK FREQUENCY

(75) Inventors: Jae-Hyun LEE, Suwon-si (KR); Jin Wan JUN, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/761,670

(22) Filed: Apr. 16, 2010

(30) Foreign Application Priority Data
Apr. 17, 2009 (KR) 10-2009-0033457

(51) Int. Cl. G06F 1/00

(52) U.S. Cl. 713/322

(57) ABSTRACT

A clock frequency adjusting method capable of reducing power consumption without reducing a response speed for a command output from a host in an idle mode is provided. In the clock frequency adjusting method, a central processing unit (CPU) generates a detection signal according to whether an interrupt signal is activated, and a frequency adjusting circuit provides a clock signal having a first frequency or a second frequency higher than the first frequency to the CPU in response to the detection signal.

### CROSS-REFERENCE TO RELATED APPLICATIONS

This application claims priority to Korean Patent Application No. 10-2009-0033457, filed on Apr. 17, 2009, in the Korean Intellectual Property Office, the disclosure of which is incorporated herein in its entirety by reference.

### BACKGROUND

An exemplary embodiment relates to clock frequency adjustment technology, and more particularly, to a method and apparatus capable of reducing power consumption without reducing a response speed for a command output from a host in an idle mode.

The hard disk drive (HDD) enters into an idle mode according to the frequency of input of commands and a predetermined time in order to minimize power consumption. In the idle mode (or an idle state), the HDD maintains only a certain revolution per minute (RPM) of a magnetic disk and the loading state of a magnetic head in order to prevent the performance of the HDD from being degraded due to a delay in the response speed for a next command output from a host. The idle mode or an idle time denotes a state in which a request of the host is not made for a predetermined period of time or more. In the idle mode of the HDD, reduction of power consumption is important, and an increase in a response speed for a command output from the host is also important.

### SUMMARY

The exemplary embodiments provide a method and apparatus capable of reducing power consumption without reducing a response speed for a command output from a host in an idle mode.

According to an exemplary embodiment, there is provided a clock frequency adjusting method including generating a detection signal according to whether an interrupt signal is activated, wherein the generating is performed in a central processing unit (CPU); and providing a clock signal having a first frequency or a second frequency higher than the first frequency to the CPU in response to the detection signal, wherein the providing is performed in a frequency adjusting circuit.

The generating of the detection signal and the providing of the clock signal to the CPU may be performed in an idle mode of a hard disk drive (HDD).

When the CPU generates a detection signal having a first state in response to the interrupt signal deactivated in an idle mode, the frequency adjusting circuit may provide the clock signal having the first frequency to the CPU in response to the detection signal having the first state. When the CPU generates a detection signal having a second state in response to the interrupt signal activated in the idle mode, the frequency adjusting circuit may provide the clock signal having the second frequency to the CPU in response to the detection signal having the second state.

According to another exemplary embodiment, there is provided a data processing device including a CPU for generating a detection signal according to whether an interrupt signal is activated; and a frequency adjusting circuit for providing a clock signal having a first frequency or a second frequency higher than the first frequency to the CPU in response to the detection signal output from the CPU.

When the data processing device is an HDD, the frequency adjusting circuit in an idle state may output the clock signal having the first frequency to the CPU in response to the deactivated detection signal output from the CPU, and the frequency adjusting circuit in the idle state may output the clock signal having the second frequency to the CPU in response to the activated detection signal output from the CPU.

According to another exemplary embodiment, there is provided a clock frequency adjusting method including generating a clock signal having a first frequency or a second frequency higher than the first frequency according to whether an interrupt signal is activated, in an idle mode, wherein the generating is performed in a frequency adjusting circuit; and operating in response to the clock signal having the first frequency or the second frequency in the idle mode, wherein the operating is performed in the CPU.

According to another exemplary embodiment, there is provided a data processing device including a frequency adjusting circuit for generating a clock signal having a first frequency or a second frequency higher than the first frequency according to whether an interrupt signal is activated, in an idle mode; and a CPU operating in response to the clock signal having the first frequency or the second frequency in the idle mode.

The data processing device may be an HDD, and the HDD may further include a signal generation circuit for generating the interrupt signal in response to a servo gate signal.

According to yet another exemplary embodiment, there is provided a clock generating method including: generating by a clock generation unit, a first clock of a first frequency or a second clock of a second frequency, that is output to a processor; operating by the processor, in a first mode or a second mode based on the first or the second clock received from the clock generation unit.

The clock generating method may generate the first or the second clock is based on an input signal. The clock generating method may further include: receiving by the clock generation unit the input signal or a frequency determining signal to generate the first or the second clock, wherein the frequency determining signal is generated by the processor based on the input signal received by the processor.

In another exemplary embodiment, there is provided a clock changing circuit including: a clock generating unit which generates a first clock of a first frequency or a second clock of a second frequency, based on a determining signal; and a processor configured to operate in a first mode or a second mode, based on the corresponding first or second clock received from the clock generating unit.

In the clock changing circuit, the determining signal is an input signal or a frequency determining signal, wherein the input signal is received by the clock generating unit and the processor and the frequency determining signal is generated by the processor based on the input signal received by the processor.

Further, the clock generating unit includes: a phase comparator which compares a reference frequency with a divided frequency and outputs a comparison signal; a charge pump which receives the comparison signal to generate a voltage; a low pass filter which low pass filters the generated voltage; an oscillator which receives the low pass filtered generated voltage to generate the first or the second clock; and a frequency divider which receives the generated first or the second clock signal and the input signal or the frequency determining signal, to output and feedback the divided frequency to the phase comparator.

### BRIEF DESCRIPTION OF THE DRAWINGS

Exemplary embodiments will be more clearly understood from the following detailed description taken in conjunction with the accompanying drawings in which:

FIG. 1 is a schematic block diagram of a data processing device according to an exemplary embodiment;

FIG. 2 is a schematic block diagram of a data processing device according to another exemplary embodiment;

FIG. 3 is a block diagram of an exemplary embodiment of a frequency adjusting circuit illustrated in FIG. 1 or 2;

FIG. 4 is a flowchart of a clock frequency adjusting method according to an exemplary embodiment;

FIG. 5 is a timing diagram of signals that are used in the data processing device according to the exemplary embodiment illustrated in FIG. 1 or 2; and

FIG. 6 is a block diagram of a hard disk drive to which the clock frequency adjusting method according to the exemplary embodiment illustrated in FIG. 4 is applied.

### DETAILED DESCRIPTION OF THE EXEMPLARY EMBODIMENTS

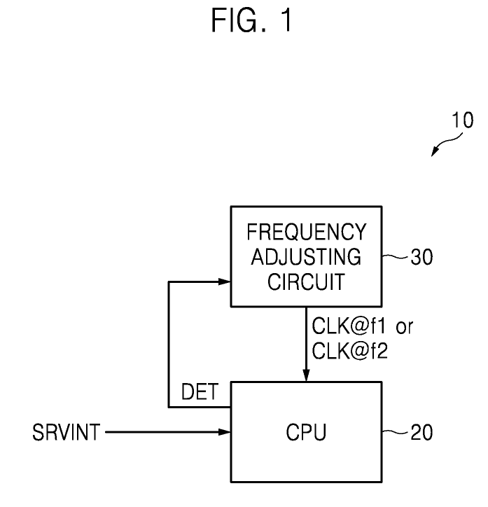

FIG. 1 is a schematic block diagram of a data processing device 10 according to an exemplary embodiment. The data processing device 10 may include a central processing unit (CPU) 20 and a frequency adjusting circuit 30. The data processing device 10 may adjust the frequency of an operating clock signal according to whether an interrupt signal is activated in an idle mode. It is noted that expressions such as “at least one of,” when preceding a list of elements, modify the entire list of elements, and do not modify the individual elements of the list.

The CPU 20 may be in or enter an idle mode or a normal operation mode according to the frequency of input of commands output from a host and/or an operating time. The normal operation mode may denote a data program operation, a data write operation, a data read operation, or a data erase operation. The CPU 20 may receive the command output from the host and perform a data access operation, for example, a program operation, a write operation, a read operation, or an erase operation, according to the received command.

In the idle mode, the CPU 20 may detect whether an externally-input interrupt signal SRVINT is activated, and may generate a detection signal DET depending on a result of the detection. The CPU 20 may denote a processor, a microprocessor, or a digital signal processor (DSP) that are capable of performing the data access operation according to a clock signal CLK.

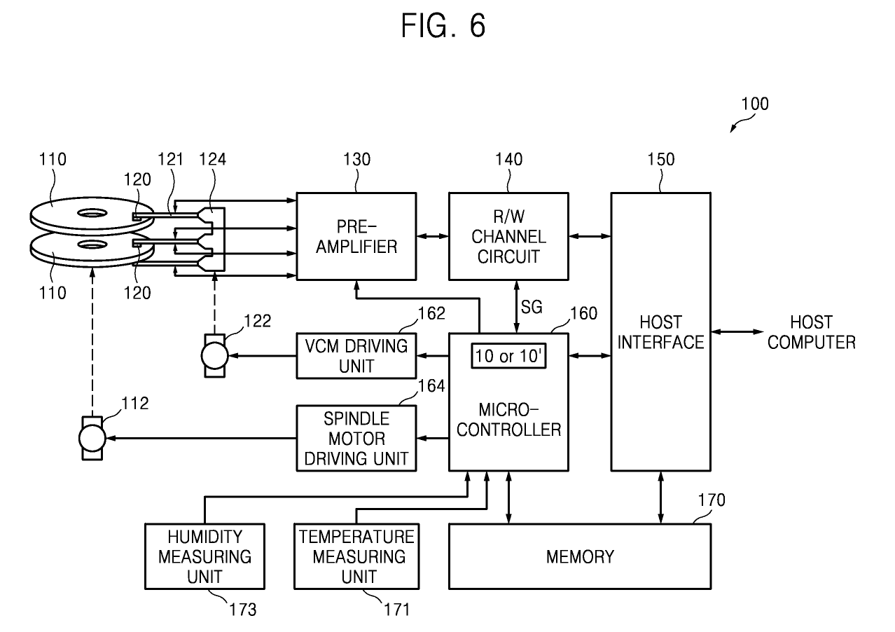

According to an exemplary embodiment, when the data processing device 10 is implemented in a hard disk drive (HDD) or forms a part of an HDD, the data processing device 10 may further include a signal generation circuit (not shown) that generates the interrupt signal SRVINT in response to a control signal, for example, a servo gate signal. The signal generation circuit may be a read/write (RW) channel circuit 140 illustrated in FIG. 6.

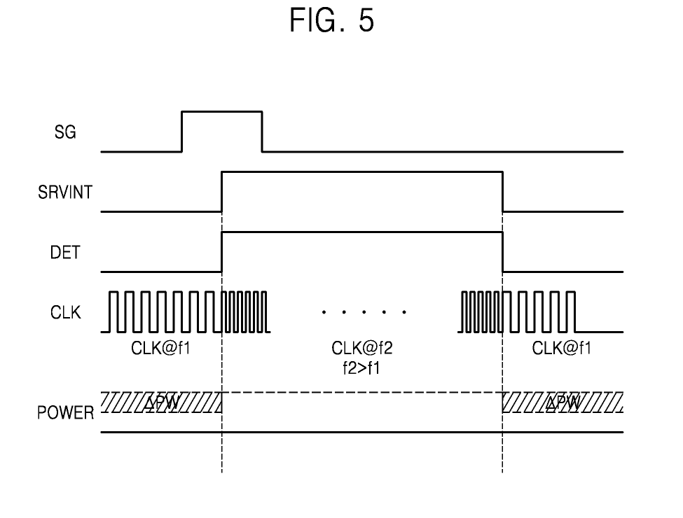

For example, as illustrated in FIG. 5, in the idle mode of the data processing device 10, the CPU 20 may generate a detection signal DET having a first level (for example, a low level) in response to a deactivated (for example, low level) interrupt signal SRVINT or a detection signal DET having a second level (for example, a high level) in response to an activated (for example, high level) interrupt signal SRVINT.

The frequency adjusting circuit 30 may output a clock signal CLK@f1 having a first frequency or a clock signal CLK@f2 having a second frequency to the CPU 20, according to the level of the detection signal DET. The first frequency may be lower than the second frequency. In some exemplary embodiments, the first frequency may be higher than the second frequency.

For example, in the idle mode of the data processing device 10, the frequency adjusting circuit 30 may output the clock signal CLK@f1 having the first frequency to the CPU 20 in response to the detection signal DET having the first level or the clock signal CLK@f2 having the second frequency to the CPU 20 in response to the detection signal DET having the second level.

In this case, the CPU 20 may perform a predetermined data processing operation in response to the clock signal CLK@f2 having the second frequency. The data processing device 10 may perform a normal operation, for example, a data write operation or a data read operation, in response to the clock signal CLK@f2 having the second frequency. When in or entering into the idle mode, the data processing device 10 may operate in response to the clock signal CLK@f1 having the first frequency in order to reduce power consumption.

In some exemplary embodiments, the frequency adjusting circuit 30 may be implemented into a phase locked loop (PLL) or a delay locked loop (DLL). The frequency adjusting circuit 30 may include any type of frequency generating circuit as long as it is capable of adjusting an output frequency in response to a control signal, for example, the detection signal DET.

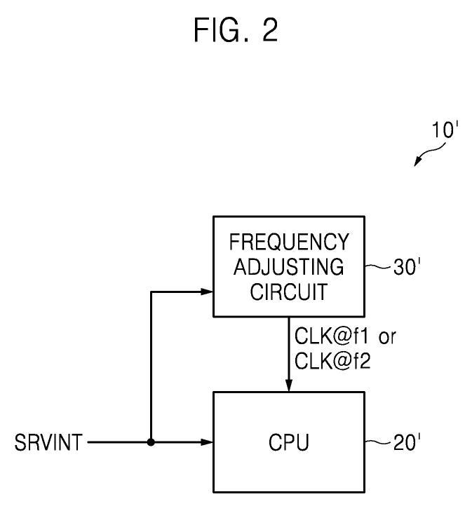

FIG. 2 is a schematic block diagram of a data processing device 10′ according to another exemplary embodiment. Referring to FIGS. 1 and 2, the data processing device 10′ may include a frequency adjusting circuit 30′ that receives an interrupt signal SRVINT.

The CPU 20′ may enter an idle mode or a normal operation mode according to an operating time or the frequency of input of a command output from a host.

In an idle state (or idle mode) of the data processing device 10′, the frequency adjusting circuit 30′ may supply the clock signal CLK@f1 having the first frequency to the CPU 20′ in response to a deactivated interrupt signal SRVINT. Thus, the CPU 20′ may maintain the idle state in response to the clock signal CLK@f1 having the first frequency. Thus, the CPU 20′ operates in response to the clock signal CLK@f1 having the first frequency lower than the second frequency in the idle mode, thus reducing power consumption.

However, when an activated interrupt signal SRVINT is generated in the idle mode of the data processing device 10′, the frequency adjusting circuit 30′ may supply the clock signal CLK@f2 having the second frequency to the CPU 20′ in response to the activated interrupt signal SRVINT. Thus, the CPU 20′ may perform a predetermined operation indicated by the activated interrupt signal SRVINT in response to the clock signal CLK@f2 having the second frequency.

When the activated interrupt signal SRVINT is deactivated again, the frequency adjusting circuit 30′ may supply the clock signal CLK@f1 having the first frequency to the CPU 20′ in response to the deactivated interrupt signal SRVINT. Thus, the CPU 20′ may return to the idle mode in response to the clock signal CLK@f1 having the first frequency. Thus, when the interrupt signal SRVINT is deactivated in the idle mode, power to be consumed in the CPU 20′ is reduced.

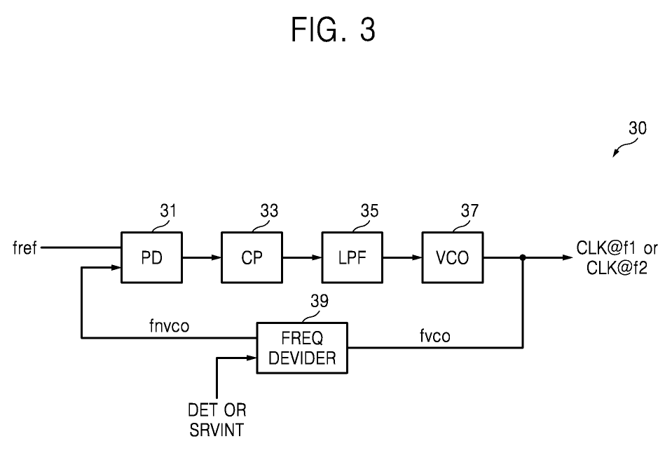

FIG. 3 is a block diagram of an exemplary embodiment of the frequency adjusting circuit 30 or 30′ illustrated in FIG. 1 or 2. FIG. 3 illustrates the frequency adjusting circuit 30 or 30′ implemented into a PLL. The frequency adjusting circuit 30 or 30′ may include a phase comparator 31, a charge pump 33, a low pass filter 35, a voltage controlled oscillator 37, and a frequency divider 39.

The phase comparator 31 receives a signal having a reference frequency fief and a signal having a divided frequency fnvco obtained by the frequency divider 39 and compares the two signals with each other to generate a comparison signal. The charge pump 33 generates a voltage that is controlled according to the comparison signal output from the phase comparator 31. The low pass filter 35 performs low pass filtering on the voltage and generates a low pass filtered voltage. The voltage controlled oscillator 37 may supply a feedback signal (for example, the clock signal CLK@f1 or CLK@f2) having a frequency fvco proportional to the low pass filtered voltage to the CPU 20 or 20′.

The frequency divider 39 may divide the frequency fvco of the feedback signal output from the voltage controlled oscillator 37 according to a frequency divide ratio in response to the detection signal DET output from the CPU 20 of FIG. 1 or the interrupt signal SRVINT of FIG. 2 and output a signal having the divided frequency fnvco to the phase comparator 31. In other words, the frequency divide ratio of the frequency divider 39 may be controlled in response to the detection signal DET or the interrupt signal SRVINT.

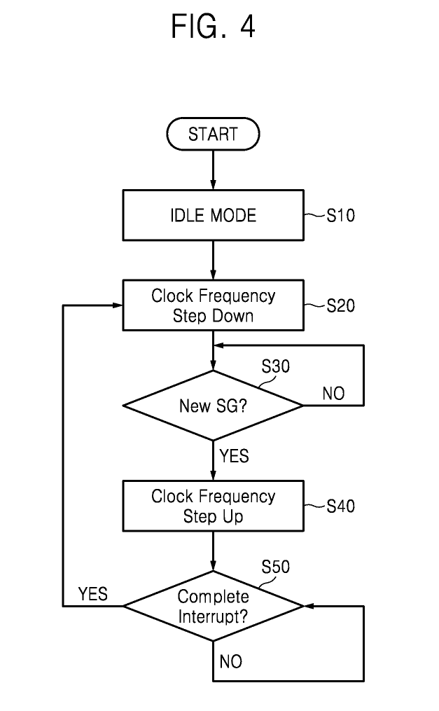

FIG. 4 is a flowchart of a clock frequency adjusting method according to an exemplary embodiment. FIG. 5 is a timing diagram of signals that are used in the data processing device 10 or 10′ illustrated in FIG. 1 or 2.

The clock frequency adjusting method according to an exemplary embodiment will now be described with reference to FIGS. 1 through 5. During a data access operation, for example, a data write operation or a data read operation, the frequency adjusting circuit 30 or 30′ may supply the clock signal CLK@f2 having the second frequency to the CPU 20 or 20′.

As illustrated in FIG. 1, when the data processing device 10 or the CPU 20 enters into an idle mode in operation S10, the CPU 20 may output the detection signal DET having the first level to the frequency adjusting circuit 30 in response to the deactivated interrupt signal SRVINT. Thus, the frequency adjusting circuit 30 may output the clock signal CLK@f1 having the first frequency to the CPU 20 in response to the detection signal DET having the first level, in operation S20.

In the idle mode, when a servo gate signal SG is activated in operation S30, the CPU 20 may output the detection signal DET having the second level to the frequency adjusting circuit 30 according to the activated servo gate signal SG in response to an activated interrupt signal SRVINT. Thus, the frequency adjusting circuit 30 may output the clock signal CLK@f2 having the second frequency to the CPU 20 in response to the detection signal DET having the second level, in operation S40. At this time, the frequency divider 39 may adjust the frequency divide ratio in response to the detection signal DET having the second level and output a clock signal CLK@f2 having a divided frequency to the CPU 20, in operation S40.

The CPU 20 may determine whether interruption is completed, on the basis of the interrupt signal SRVINT, in operation S50. When the interruption is completed, the interrupt signal SRVINT is deactivated. Thus, the CPU 20 may output the detection signal DET having the first level to the frequency adjusting circuit 30 in response to the deactivated interrupt signal SRVINT. Thus, the method goes back to the operation S20 so that the frequency adjusting circuit 30 outputs the clock signal CLK@f1 having the first frequency again to the CPU 20 in response to the detection signal DET having the first level in order to reduce power consumption.

As illustrated in FIG. 5, the CPU 20 or 20′ of the data processing device 10 or 10′ according to an exemplary embodiment may operate in response to the clock signal CLK@f1 having the first frequency or the clock signal CLK@f2 having the second frequency according to whether the interrupt signal SRVINT is activated in the idle mode. However, a conventional CPU operates in response to a clock signal having an identical frequency, regardless of whether an interrupt signal is activated in the idle mode. Thus, when the interrupt signal SRVINT is deactivated in the idle mode, power consumed in the CPU 20 or 20′ of the data processing device 10 or 10′ according to an exemplary embodiment may be ΔPW less than power consumed in the conventional CPU.

In other words, the data processing device 10 or 10′ may detect a current operation mode and perform a data processing operation according to clock signals having different frequencies according to a result of the detection and activation or deactivation of the interrupt signal SRVINT.

A frequency adjusting method performed in the data processing device 10′ of FIG. 2 according to whether the interrupt signal SRVINT is activated may be sufficiently understood by referring to FIGS. 2 and 4, and thus a detailed description thereof will be omitted.

FIG. 6 is a block diagram of an HDD 100 to which the clock frequency adjusting method according to the exemplary embodiment illustrated in FIG. 4 is applied. Referring to FIG. 6, the HDD 100 may include the data processing device 10 or 10′ according to an exemplary embodiment.

The HDD 100 may include a plurality of data storage media 110 (for example, magnetic disks), a spindle motor 112, a plurality of magnetic heads 120, a voice coil motor (VCM) 122, an actuator 124, a pre-amplifier 130, a R/W channel circuit 140, a host interface 150, a microcontroller 160, a VCM driving unit 162, a spindle motor driving unit 164, and a memory 170.

The HDD 100 may further include a temperature measuring unit 171 or a humidity measuring unit 173. Each of the data storage media 110 may include a plurality of tracks which are concentric, and may be rotated by the spindle motor 112. Each of the magnetic heads 120 may be located over a corresponding storage medium from among the data storage media 110 to perform a read operation or a write operation under the control of the microcontroller 160. Each of the magnetic heads 120 may include a write head and a read head and may be installed on a slider (not shown).

Each of the magnetic heads 120 may be installed on each of a plurality of flexible suspension arms (not shown) installed on each of a plurality of rigid actuator arms 121 attached to an actuator 124. The rigid actuator arms 121 may move the magnetic heads 120, respectively, to over the tracks of the data storage media 110 under the control of the VCM 122.

Each of the magnetic heads 120 may read a predetermined pattern from a predetermined area of each of the data storage media 110 and generate an analog read signal.

When data is read from each of the data storage media 110, the pre-amplifier 130 may receive and amplify an analog read signal output from a corresponding magnetic head (in more detail, a read head) from among the magnetic heads 120 and output an amplified analog read signal to the R/W channel circuit 140.

When data is written to each of the data storage media 110, the pre-amplifier 130 may control a write signal received from the R/W channel circuit 140 to be written to a corresponding data storage medium from among the data storage media 110 via a corresponding magnetic head (in more detail, a write head) from among the magnetic heads 120.

The R/W channel circuit 140 may detect a data pulse from the amplified analog read signal output from the pre-amplifier 130, decode the data pulse, and output read data to the host interface 150. The R/W channel circuit 140 may encode write data output from the host interface 150 to supply a write signal to the pre-amplifier 130. The read data or the write data may be temporarily stored in the memory 170.

Under the control of the microcontroller 160, the host interface 150 may transmit the write data which is to be written to the data storage media 110 to the R/W channel circuit 140, or may transmit the read data read out of the data storage media 110 to a host computer. The host interface 150 may also transmit a read command signal or a write command signal received from the host computer to the microcontroller 160 or the memory 170, and transmit the read data or write data stored in the memory 170 to the host computer or the R/W channel circuit 140 in response to a control signal output from the microcontroller 160. Thus, the host interface 150 may interface a communication between the host computer and the R/W channel circuit 140, a communication between the microcontroller 160 and the host computer, a communication between the memory 170 and the host computer, a communication between the memory 170 and the microcontroller 160, or a communication between the memory 170 and the R/W channel circuit 140.

The microcontroller 160 may output the control signal to the R/W channel circuit 140 via the host interface 150 in response to the read command signal or the write command signal output from the host computer and may control the VCM driving unit 162 and the spindle motor driving unit 164 to control a track seek and/or track following on the basis of servo information received from the R/W channel circuit 140. The microcontroller 160 may output the servo gate signal SG to the R/W channel circuit 140 or receive the servo gate signal SG from the R/W channel circuit 140. In some exemplary embodiments, the R/W channel circuit 140, the host interface 150, and the microcontroller 160 may be formed into a single chip. In some exemplary embodiments, the host interface 150 and the microcontroller 160 may constitute a single HDD controller.

The microcontroller 160 may be implemented into a digital signal processor or a microprocessor. The microcontroller 160 may also be referred to as a CPU. In some exemplary embodiments, the microcontroller 160 may be the CPU 20 or 20′ of FIG. 1 or 2, or may be a part of the CPU 20 or 20′, or may include the CPU 20 or 20′. Thus, in some exemplary embodiments, the frequency adjusting circuit 30 or 30′ may be installed inside or outside the microcontroller 160.

The memory 170 may temporarily store data communicated between the host computer, the microcontroller 160, and the R/W channel circuit 140, and store various programs to be performed in the microcontroller 160 and various set values.

The VCM driving unit 162 may generate a driving current for driving the VCM 122 in response to position control signals provided from the microcontroller 160. The position control signals may be signals for controlling the positions of magnetic heads. The position control signals may be generated based on the servo information output from the R/W channel circuit 140. The VCM 122 may move a corresponding magnetic head from among the magnetic heads 120 attached to the actuator 124 to over a corresponding data storage medium from among the data storage media 110 on the basis of a direction and/or level of the driving current received from the VCM driving unit 162.

The spindle motor driving unit 164 may drive the spindle motor 112 according to the control signal generated by the microcontroller 160 to rotate the data storage media 110 at a predetermined rotation speed (for example, 3600 through 7200 rpm). The VCM driving unit 162 and the spindle motor driving unit 164 may be formed into a signal chip.

The temperature measuring unit 171 may measure the internal temperature of a data storage device, namely, the HDD 100, and transmit a signal corresponding to a result of the measurement to the microcontroller 160. The humidity measuring unit 173 may measure the internal humidity of the data storage device 100 and transmit a signal corresponding to a result of the measurement to the microcontroller 160.

The data processing device 10 or 10′ according to an exemplary embodiment may be installed inside or outside the microcontroller 160. The data processing device 10 or 10′ may operate at different frequencies according to whether the interrupt signal SRVINT is activated in the idle mode. In some exemplary embodiments, only the frequency adjusting circuit 30 or 30′ may be installed inside or outside the microcontroller 160. In this case, the clock signal CLK@f1 or CLK@f2 output from the frequency adjusting circuit 30 or 30′ may be provided to a core logic capable of performing the functions of a CPU. Thus, the core may perform an operation according to the clock signal CLK@f1 or CLK@f2 output from the frequency adjusting circuit 30 or 30′.

In other words, in some exemplary embodiments, the CPU 20 or 20′ and the frequency adjusting circuit 30 or 30′ of FIG. 1 or 2 may constitute at least a part of the microcontroller 160. The data processing device 10 or 10′ may be used in all electronic apparatuses that require the CPU 20 in order to perform data processing, such as, PCs, mobile phones, memory cards, smart cards, e-books, digital TVs, IPTVs, printers, personal digital assistants (PDAs), portable multi-media players (PMPs), and MP3 players.

In a clock frequency adjusting method and a data processing device according to an exemplary embodiment, an operating frequency of a CPU may be adjusted according to whether an interrupt signal is activated in an operation mode, for example, in an idle mode. Thus, the data processing device may reduce power consumption without reducing a response speed for a command output from a host in the idle mode.

While the present invention has been particularly shown and described with reference to exemplary embodiments thereof, it will be understood that various changes in form and details may be made therein without departing from the spirit and scope of the following claims.

1.-3. (canceled)

4. A data processing device comprising:
a CPU which generates a detection signal based on an interrupt signal; and
a frequency adjusting circuit which provides a clock signal comprising a first frequency or a second frequency higher than the first frequency to the CPU in response to the detection signal generated by the CPU.

5. The data processing device of claim 4, wherein when the data processing device is a hard disk drive, the frequency adjusting circuit in an idle state outputs the clock signal comprising the first frequency to the CPU in response to the detection signal of a first level output from the CPU, and the frequency adjusting circuit in the idle state outputs the clock signal having the second frequency to the CPU in response to the detection signal of a second level output from the CPU.

6. (canceled)

7. A data processing device comprising:
a frequency adjusting circuit which generates a clock signal comprising a first frequency or a second frequency higher than the first frequency based on an interrupt signal, in an idle mode; and
a CPU which operates in response to the clock signal comprising the first frequency or the second frequency in the idle mode.

8. The data processing device of claim 7, wherein:
the data processing device is a hard disk drive; and
the hard disk drive further comprises a signal generation circuit which generates the interrupt signal in response to a servo gate signal.

9.-11. (canceled)

12. A clock changing circuit comprising:
a clock generating unit which generates a first clock of a first frequency or a second clock of a second frequency, based on a determining signal; and
a processor configured to operate in a first mode or a second mode, based on the corresponding first or second clock received from the clock generating unit.

13. The clock changing circuit of claim 12, wherein the determining signal is an input signal or a frequency determining signal, wherein the input signal is received by the clock generating unit and the processor and the frequency determining signal is generated by the processor based on the input signal received by the processor.

14. The clock changing circuit of claim 13, wherein the clock generating unit comprises:
a phase comparator which compares a reference frequency with a divided frequency and outputs a comparison signal;
a charge pump which receives the comparison signal to generate a voltage;
a low pass filter which low pass filters the generated voltage;
an oscillator which receives the low pass filtered generated voltage to generate the first or the second clock; and
a frequency divider which receives the generated first or the second clock signal and the input signal or the frequency determining signal, to output and feedback the divided frequency to the phase comparator.
